(19) United States
(12) Patent Application Publication
(10) Pub. No.: US 2013/0121374 A1
(43) Pub. Date: May 16, 2013

(54) FIBER OPTIC BIREFRINGENT THERMOMETER AND METHOD FOR MANUFACTURING THE SAME

(71) Applicant: ABB Research Ltd, Zurich (CH)

(72) Inventors: Robert Wüest, Zurich (CH); Tilo Buehler, Othmarsingen (CH); Florian Buchter, Fribourg (CH)

(73) Assignee: ABB RESEARCH LTD, Zurich (CH)

(21) Appl. No.: 13/735,460

(22) Filed: Jan. 7, 2013

Related U.S. Application Data
(63) Continuation of application No. PCT/EP2010/059722, filed on Jul. 7, 2010.

(51) Int. Cl. G01K 11/32; G01K 15/00

(52) U.S. Cl. CPC G01K 11/32; G01K 15/00
USPC 374/161; 29/407.05

(57) ABSTRACT

A fiber optic thermometer is provided that uses a birefringent polarization maintaining sensing fiber as well as a single-mode transmission fiber for transmitting the optical signals between the sensing head and an optoelectronic module. The optoelectronic module contains two light sources operating at different spectral ranges. The unpolarized light from the light sources is sent through the transmission fiber, sent through a polarizer, and coupled into both birefringence axis of the sensing fiber. The waves are reflected at a reflector at a remote end of the sensing fiber, whereupon it returns through the sensing fiber, the polarizer and the transmission fiber. By analyzing the returned signal for both spectral ranges, a robust temperature signal can be derived. This thermometer design obviates the need for using a polarization maintaining fiber and polarization maintaining connectors between the optoelectronic module and the sensor head.

### RELATED APPLICATION

This application claims priority as a continuation application under 35 U.S.C. §120 to PCT/EP2010/059722 filed as an International Application on Jul. 7, 2010 designating the U.S., the entire content of which is hereby incorporated by reference in its entirety

### FIELD

The present disclosure relates to a fiber optic thermometer having a polarization maintaining sensing fiber whose birefringence depends on a temperature to be measured. The present disclosure also relates to a method for manufacturing such a thermometer.

### BACKGROUND INFORMATION

Fiber optic thermometers are used in medium voltage and high voltage applications, for example, for measuring the temperature of generator circuit breakers or power transformers. The main challenge for a temperature measurement system under such conditions is the reliable detection of the temperature on an electric potential in the order of some 10 kV or more with a suitable signal transmission to a monitoring unit in the control cabinet on ground potential.

It is known from W. Eickhoff, “Temperature sensing by mode-mode interference in birefringent optical fibers”, Opt. Lett., 6(4), 204, (1981), that the temperature dependence of the differential phase velocity of polarization maintaining (PM) fibres makes it possible to encode the temperature information as a polarization state. Such a potentially cheap polarization measurement is also not affected by EMI, vibration, humidity and offers potential for a long lifetime, and optical signals can be readily transferred between ground and medium/high voltage potentials by means of optical transmission fibers.

A reflective polarization interferometer with a good down lead insensitivity has been proposed in M. Corke, A. D. Kersey, K. Liu, D. A. Jackson, “Remote Temperature Sensing using Polarisation-Preserving Fibre”, Electron. Lett., 20(2), 67, (1984). The concept relies on undisturbed transport of the polarization state from the sensing element to the read-out (opto-) electronics through a transmission fiber, which necessitates delicate and expensive PM connectors.

In another known method disclosed in A. D. Kersey, M. Corke, D. A. Jackson, “Linearised Polarimetric Optical Fibre Sensor using a Heterodyne-Type Signal Recovery Scheme”, Electron. Lett., 20(5), 209, (1984), and A. D. Kersey, M. A. Davis, M. J. Marrone, “Differential polarimetric fiber-optic sensor configuration with dual wavelength operation”, Appl. Opt., 28(2), 204, (1989), the measurand (e.g. stress, temperature) was deduced from the differential response, in this case the phase, of two wavelengths travelling through a PM fiber.

U.S. Pat. No. 6,211,962 discloses a birefringent fiber-optic sensor which uses wavelength-multiplexing for separately measuring a plurality of measurands in different fiber sections and hence at different locations along the sensing fiber. In particular, with each wavelength a separate temperature signal assigned to a different location can be measured.

### SUMMARY

An exemplary embodiment of the present disclosure provides a fiber optic thermometer which includes a light source assembly configured to generate light in a first spectral range and in a second spectral range. The first spectral range differs from the second spectral range. The exemplary thermometer also includes a single-mode transmission fiber connected to the light source assembly and configured to carry the light of the first and second spectral ranges, and a polarizer configured to polarize light from the transmission fiber. In addition, the exemplary thermometer includes a polarization maintaining sensing fiber having first and second birefringence axes. A birefringence of the sensing fiber between the first and second birefringence axes depends on a temperature to be measured, and the polarizer is configured to couple light from the light source into both the birefringence axes. The sensing fiber has a first end and a second end, and the polarizer is arranged between the transmission fiber and the first end. The exemplary thermometer also includes a reflector arranged at the second end of the sensing fiber and configured to reflect light back into the sensing fiber, and a detector assembly configured to detect light returning from the sensing fiber through the polarizer and the single-mode transmission fiber. The detector assembly is configured to generate a first signal A indicative of an intensity of returning light in the first spectral range, and a second signal B indicative of an intensity of returning light in the second spectral range. The exemplary thermometer also includes processing circuitry configured to generate a temperature signal from the first signal A and the second signal B. The processing circuitry is configured to calculate a temperature signal S from the first signal A and the second signal B that is an unambiguous function of the temperature over a desired temperature range.

An exemplary embodiment of the present disclosure provides a method for manufacturing fiber optic thermometer. The exemplary method includes: arranging a light source assembly configured to generate light in a first spectral range and in a second spectral range, the first spectral range differing from the second spectral range; arranging a single-mode transmission fiber connected to the light source assembly and carrying the light of the first and second spectral ranges; arranging a polarizer configured to polarize light from the transmission fiber; arranging a polarization maintaining sensing fiber having first and second birefringence axes, wherein a birefringence of the sensing fiber between the first and second birefringence axes depends on a temperature to be measured, and the polarizer is configured to couple light from the light source into both the birefringence axes, the sensing fiber having a first end and a second end, and the polarizer being arranged between the transmission fiber and the first end; arranging a reflector arranged at the second end of the sensing fiber and configured to reflect light back into the sensing fiber; arranging a detector assembly configured to detect light returning from the sensing fiber through the polarizer and the single-mode transmission fiber, wherein the detector assembly is configured to generate a first signal A indicative of an intensity of returning light in the first spectral range and a second signal B indicative of an intensity of returning light in the second spectral range; arranging processing circuitry configured to generate a temperature signal from the first signal A and the second signal B, the processing circuitry being configured to calculate a temperature signal S from the first signal A and the second signal B that is an unambiguous function of the temperature over a desired temperature range; providing the sensing fiber to have an original birefringent retardation exceeding a desired birefringent retardation; sending light through the sensing fiber polarized along the first and the second birefringence axes of the sensing fiber; measuring a parameter depending on a current retardation in the sensing fiber; and permanently reducing the birefringence of the sensing fiber by tempering the sensing fiber until the parameter indicates that the current retardation is equal to the desired retardation.

### BRIEF DESCRIPTION OF THE DRAWINGS

Additional refinements, advantages and features of the present disclosure are described in more detail below with reference to exemplary embodiments illustrated in the drawings, in which:

FIG. 1 shows an exemplary embodiment of a thermometer according to the present disclosure;

FIG. 2 shows an exemplary embodiment of a thermometer according to the present disclosure;

FIG. 3 shows first and second signals A, B as measured by the thermometer, as well as two signals derived from A and B, according to an exemplary embodiment of the present disclosure;

FIG. 4 shows a manufacturing setup according to an exemplary embodiment of the present disclosure; and

FIG. 5 shows a sensor head according to an exemplary embodiment of the present disclosure.

### DETAILED DESCRIPTION

Exemplary embodiments of the present disclosure provide a cost effective and rugged fiber optic thermometer as well as a method for manufacturing the same.

Features of the thermometer and method according to the present disclosure are described in more detail below with reference to exemplary embodiments illustrated in the drawings.

An exemplary embodiment of the present disclosure provides a fiber optic thermometer which includes a light source assembly configured to generate light in at least two different spectral ranges, for example, in a first spectral range and in a second spectral range, where the first spectral range differs from the second spectral range. The exemplary thermometer also includes a single-mode transmission fiber which is directly or indirectly connected to the light source assembly and configured to carry the light of both the first and second spectral ranges. In accordance with an exemplary embodiment, the transmission fiber may not be a polarization maintaining fiber. The exemplary thermometer also includes a polarizer which is arranged and configured to polarize the light exiting at the remote end of the transmission fiber. The light from the polarizer is then sent (through an optional polarization maintaining lead fiber) into a sensing fiber. The sensing fiber is a polarization maintaining fiber having first and second birefringence axes, with the birefringence between the axes depending on the temperature to be measured. The mutual arrangement of the polarizer and the sensing fiber is such that the light from the polarizer is coupled into both birefringence axes of the sensing fiber.

The sensing fiber has a first end, at which it receives the light from the polarizer, and a second end. A reflector is arranged at the second end and reflects light back into the sensing fiber, such that it passes back through the sensing fiber, the polarizer and the transmission fiber.

A detector assembly is provided to detect the light returning from the sensing fiber through the polarizer and the transmission fiber. The detector assembly generates a first signal A indicative of an intensity of the returning light in the first spectral range, and a second signal B indicative of the intensity of the returning light in the second spectral range.

The signals A and B are fed to processing circuitry for generating a temperature signal from both of them.

This design advantageously does not require a polarization maintaining fiber or polarization maintaining connectors between the ground-based optoelectronic module (light source assembly, detector assembly) and the sensing head (polarizer, sensing fiber), while the measurement at two wavelengths allows accurate results to be obtained even when the connector quality between the ground-based equipment and the sensing head varies.

In accordance with an exemplary embodiment, the thermometer may also include a polarization maintaining lead fiber arranged between the polarizer and the first end of the sensing fiber. The birefringence axes of the lead fiber are parallel and perpendicular to the polarization direction of the polarizer, such that the polarizer couples its light into only one of them. The birefringence axes of the lead fiber are, on the other hand, at an angle between 40° and 50°, for example, at an angle of 45°, with respect to the birefringence axes of the sensing fiber such that light is coupled into both axes of the sensing fiber. This design advantageously allows the polarizer to be maintained at a distance from the sensing fiber such that only the sensing fiber, but not the polarizer, needs to be at the temperature to be measured.

In accordance with an exemplary embodiment, the processing circuitry may be configured to calculate a temperature signal from the signals A and B that allows to unequivocally determine the temperature in a given measurement range, for example, by calculating a quantity depending on

(A−B)/(A+B)

or on

log(A/B).

The method for manufacturing the thermometer according to the present disclosure deals with the issue that it is difficult to manufacture a fiber of an exactly correct length. The method according to the present disclosure solves this issue by the following steps:

a) Providing the sensing fiber with a total retardation that slightly exceeds a desired given retardation.

b) Sending light through the sensing fiber polarized along the first and second birefringence axes of the sensing fiber. The polarization components of such light will suffer a mutual phase shift given by the retardation of the sensing fiber.

c) Measuring a parameter depending on a current retardation in the fiber by analyzing the light exiting from the fiber.

d) Permanently reducing the birefringence of the sensing fiber by tempering the sensing fiber (i.e. by exposing it to such high temperatures that its birefringence decreases due to non-reversible effects) until the parameter indicates that the current retardation is equal to the desired retardation.

A sensing fiber manufactured in this manner has a well-defined optical retardation, namely the “desired given retardation” defined in step a), at the reference temperature, which allows the processing circuitry to be replaced without recalibration.

Other advantageous features of the present disclosure are described in more detail below with reference to exemplary embodiments illustrated in the drawings.

Definitions:

The term “a signal is indicative of” a given value is to be understood that the signal is equal to the given value or depends on the given value, for example, by being derived or derivable from the given value. In accordance with an exemplary embodiment, the signal is proportional to the given value.

Thermometer:

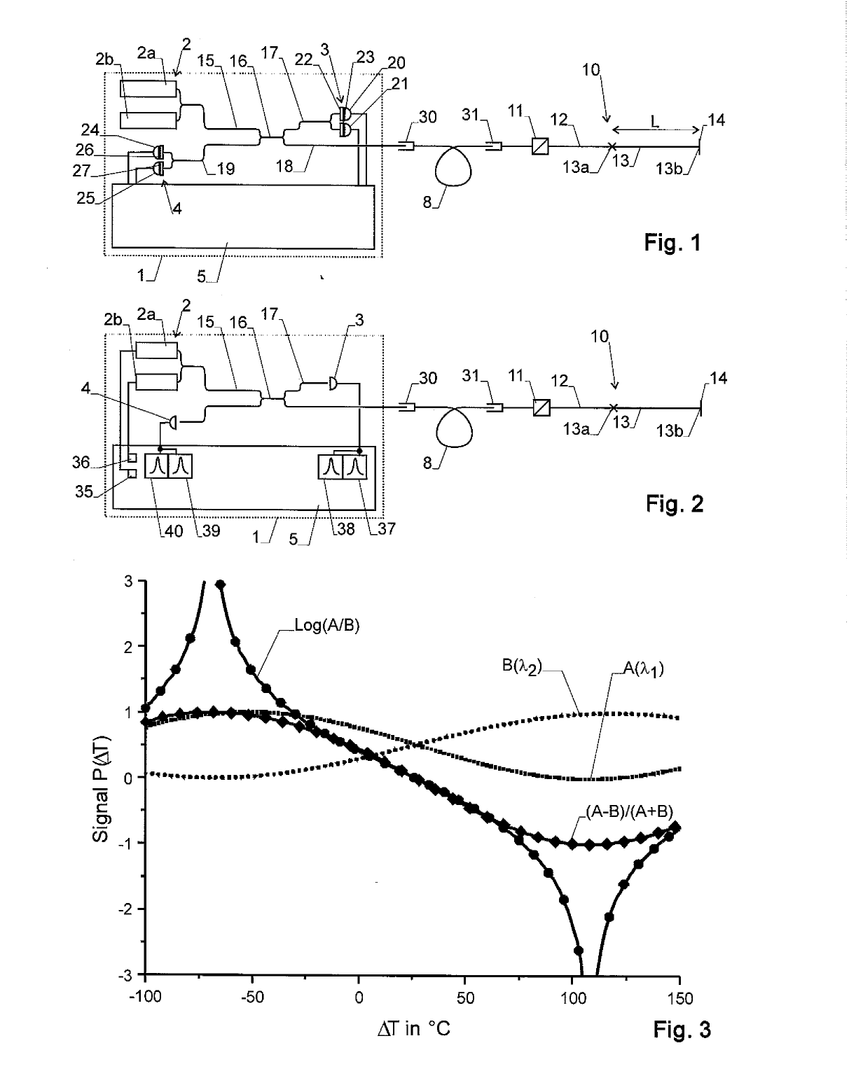

A possible temperature sensor system using the temperature sensitive birefringence of a PM sensing fiber includes three basic components as can be seen in the exemplary and illustrative embodiment of FIG. 1:

(i) An optoelectronic module 1 featuring a light source arrangement 2, detector(s) 3, 4 and processing circuitry 5. In the embodiment of FIG. 1, the light source arrangement 2 includes two light sources 2a, 2b. First light source 2a generates light in a first spectral range, and second light source 2b generates light in a second spectral range, with the two spectral ranges being different, for example, centered at 1310 nm and at 1550 nm, respectively.

(ii) A transmission fiber 8 to transmit firstly the light of both spectral ranges to the sensing head 10 and secondly to transfer the encoded temperature information back to the optoelectronic module 1.

(iii) A sensing head 10 including a wideband polarizer 11 operative in both spectral ranges, a PM lead fiber 12 and a PM sensing fiber 13 of length L. Sensing fiber 13 has a birefringence dependent on the temperature to be measured. Polarizer 11 is arranged parallel to one of the birefringence axes of lead fiber 12. In accordance with an exemplary embodiment, the birefringence axes of lead fiber 12 are under an angle of 45° with respect to the birefringence axes of sensing fiber 13. Sensing fiber 13 has a first end 13a connected to lead fiber 12 and a second end 13b, with a reflector (mirror) 14 arranged at second end 13b to reflect light back into sensing fiber 13.

In addition to the components mentioned above, the optoelectronic module 1 may also include a combiner 15 for combining the light from the light sources 2a, 2b, a coupler 16 for coupling part of the light from combiner 15 into a reference branch 17 and a measurement branch 18, and for coupling part of the light coming back from measurement branch 18 into a detection branch 19—all of these components may, for example, be implemented as waveguides and do not have to be polarization maintaining but need to be working properly at both spectral regions simultaneously.

The light from reference branch 17 is fed to a first reference detector 20 and a second reference detector 21. First reference detector 20 is equipped with an optical filter 22 such that it measures a first raw intensity signal SA₀ indicative of the intensity of light of the first spectral range as generated by light source assembly 2. Similarly, second reference detector 21 is equipped with an optical filter 23 such that it measures a second raw intensity signal SB₀ indicative of the intensity of light of the second spectral range as generated by light source assembly 2.

Similarly, the light from reference branch 19 is fed to a first and a second signal detector 24, 25, equipped with optical filters 26, 27 such that they measure a first raw return signal SA and a second raw return signal SB indicative of the intensity of light of the first and second spectral range, respectively, returning through transmission fiber 8.

Processing circuitry 5 can be configured to calculate a first signal A indicative of SA/SA₀ and a second signal B indicative of SB/SB₀, that is, the signals A and B are indicative of the intensity of the light at the first and second spectral range, respectively, normalized by the amount of light generated by light source assembly 2 in the respective spectral range.

A first single-mode connector 30 can be arranged between transmission fiber 8 and light source assembly 2, namely in the embodiment of FIG. 1 between measurement branch 18 and transmission fiber 8. A second single-mode connector 31 is arranged between transmission fiber 8 and polarizer 11.

First single-mode connector 30 allows for the optoelectronic module 1 to be replaced quickly and easily. Second single-mode connector 30 allows for the transmission fiber 8 to be disconnected from sensing head 10.

The basic sensing concept of the thermometer corresponds to the one described in M. Corke, A. D. Kersey, K. Liu, D. A. Jackson, “Remote Temperature Sensing using Polarisation-Preserving Fibre”, Electron. Lett., 20(2), 67, (1984). However, the sensor topology of M. Corke et al. is disadvantageous, because it requires a PM fiber as transmission fiber as well as delicate and costly PM connectors. In contrast to this, the design according to the present disclosure does not require a PM fiber as transmission fiber, but, for example, a single mode (SM) fiber that exhibits a radially symmetric waveguide with no preferred azimuthal direction. This greatly simplifies opening and closing the connectors without disturbing the sensor signal.

The light generated by light source assembly 2 is propagated through optoelectronic module 1 into transmission fiber 8 and is then polarized at the sensing head side by polarizer 11, which serves as a polarizer for the forward traveling light and as an analyzer for the backward traveling light. From polarizer 11, the light travels down one axis of a lead fiber 12, is split, for example, equally, into both axes of the sensing fiber 13 using a splice angle, for example, a 45° splice angle. The light therefore enters both polarization modes of sensing fiber 13, is reflected back by reflector 14 at the second end 13b of sensing fiber 13 and is coupled into both axes of the lead fiber 12 at the splice, for example, a 45° splice, where the two waves from sensing fiber 13 interfere with each other. The light polarized along one of the two axes of lead fiber 12 passes polarizer 11, travels back through transmission fiber 8 and returns to optoelectronic module 1, where the signals A and B are measured as described above to yield a measure for the temperature at sensing fiber 13. The signals A and B depend on the differential retardation

ρ(T)=ρ₀·(1+Q·dT)

between the two polarization modes in sensing fiber 13, for example, on the temperature dependent birefringence of the sensing fiber, with ρ₀ being a retardation at a reference temperature T0 (such as room temperature), dT the deviation of the reference temperature and Q a temperature coefficient. The temperature dependence of the measured retardation ρ(T) is governed by the temperature coefficient of the birefringence Q=1/ρ*(dρ/dT) and the retardation at reference (room) temperature ρ₀=4πL/L_{B}. Here, L is the length of the sensing fiber, and L_{B} is the beat length of the PM fiber type of the sensing fiber. The first and second signals A, B, as described above, are therefore:

A=0.5*(1+cos(ρ₁(T))

B=0.5*(1+cos(ρ₂(T)),

with ρ₁ and ρ₂ being the retardations at the center wavelengths λ₁, λ₂ of the first and second spectral ranges, respectively, assuming that the two spectral ranges are sufficiently narrow. The signals A, B primarily differ because of different beat lengths and temperature dependencies Q at λ₁ and λ₂.

The temperature information is encoded as the ratio of the detected light intensities at the two wavelengths and is consequently insensitive to variations of the transmissivity of, for example, the single mode connectors 30, 31. Differential fluctuations of the two light sources are corrected for by the fact that the signals A, B can be normalized by the raw signals SA₀, SB₀ as described above.

In the embodiment of FIG. 1, the signals at the two spectral ranges are separated by the optical filters 22, 23, 26, 27. FIG. 2 shows an exemplary embodiment employing two modulated sources at two different frequencies f₁ and f₂. It includes first and second amplitude modulators 35, 36 operating at f₁ and f₂, respectively. First amplitude modulator 35 cooperates with first light source 2a for modulating the intensity of the light in the first spectral range with frequency f₁, and second amplitude modulator 36 cooperates with second light source 2b for modulating the intensity of the light in the first spectral range with frequency f₂. The amplitude modulators 35, 36 can, for example, be current modulators modulating the feed currents for the light sources 2a, 2b.

The modulation amplitudes can be monitored at the forward traveling light and detected at the light coming back from the sensing head in time domain independently, using only one detector for both wavelengths. For this purpose, each light detector 3, 4 is connected to a first and a second bandpass filter 37, 38 and 39, 40, respectively. The bandpass filters 37-40 can, for example, be lock-in filters or software based filters centered on the frequencies f₁ and f₂, respectively.

FIG. 3 shows the behavior of the signals A, B and of two signals derived therefrom as a function of temperature difference ΔT=T−T₀, with T being the temperature at sensing fiber 13 and T₀ being reference or ambient temperature. The curves in FIG. 3 correspond to λ₁=1310 nm, λ₂=1550 nm and assume that the sensing fiber in an E-core fiber (elliptical core fiber) having the following properties: Q=3.2.10-4 K-1, LB=6 mm (beat length at λ₁=1310), L=29.5 mm.

In FIG. 3, it was assumed that the beat lengths are proportional to the wavelength λ₁, λ₂ and that the temperature dependence Q is equal for both wavelengths, which is justified for a first order approximation. Realistic parameters were used for wavelengths of 1310 nm and 1550 nm and for an existing elliptical core fiber, for example, a beat length of 6 mm at 1310 nm and a temperature dependence of Q=3.2.10-4 [1/K]. The signals A, B refer to the normalized light intensities or modulation amplitudes of the two wavelengths as measured by processing circuitry 5 as described above. It can be seen in FIG. 3 that for a length of the sensing fiber of L=29.5 mm an unambiguous sensing signal over a temperature range of 160° C. can be achieved. Such a temperature range is normally sufficient for applications in power products. A sensor accuracy of ±1° is possible over the above mentioned range as it is mainly determined by the measurement accuracy of the light intensity or the modulation amplitude, which should be in the ppm range.

Processing circuitry 5 can be configured to calculate a temperature signal from A and B that is an unambiguous function of the temperature over the desired temperature range.

In accordance with an exemplary embodiment, the temperature signal S can, for example, be calculated from the ratio A/B. For symmetry reasons, a well-suited quantity is, for example,

S=log(A/B).

Another well-suited quantity that is also symmetric over the measurement range is

S=(A−B)/(A+B).

Both these definitions for S are shown in FIG. 3.

In accordance with an exemplary embodiment, the PM fiber 12 between polarizer 11 and sensing fiber 13 may be protectively packaged to avoid polarization cross-coupling.

The fiber properties relevant for the sensor calibration (ρ₀, Q) are given by the light guiding core of sensing fiber 13 and are consequently well protected inside the silica glass and are not expected to show ageing due to, for example, humidity.

Manufacturing Method:

An important property of a temperature sensor is the possibility for a “one-point” calibration during manufacturing and the exchangeability of sensor heads and read-out electronics. To achieve both properties, a manufacturing method is provided which allows for the fabrication of identical sensor heads. These sensor heads can then, for example, be exchanged at the location of the single-mode connectors 30 or 31. For a given fiber type, the temperature dependence Q of the differential retardation remains constant. The sensor calibration is then purely a function of the optical length, for example, of the differential retardation ρ₀(T₀), such that a fiber with the correct overall retardation has to be manufactured.

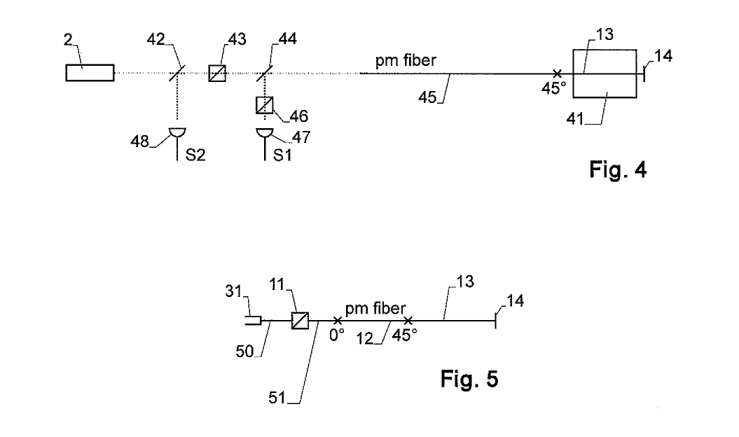

To achieve a defined retardation, the sensing fiber is initially prepared with a bit of over length. The retardation is then determined using the manufacturing set-up shown in FIG. 4. The technique is based on observing the two polarizations carried by the sensing fiber at a certain wavelength (which may or may not be equal to one of the first and second wavelengths λ₁ and λ₂ above) and at a controlled room temperature. Subsequently, the retardation ρ₀ is reduced in stepwise manner by applying heat (tempering), for example, in a splicing machine or some other tempering chamber 41. The heat may be applied to all of sensing fiber 13 or only to a section thereof. Application of heat to the PM sensing fiber, which can, for example, be an elliptical core fiber, causes the fiber core to diffuse slightly into the cladding material, thereby making the core less birefringent and consequently reducing the induced retardation in the case of an elliptical core fiber. For PM fibers employing stress bodies to generate an internal stress field, application of heat would cause the stress bodies to diffuse into the cladding and consequently change the stress field and the birefringence in the fiber core. A similar method is successfully employed for manufacturing the quarter wave retarder of the fiber optic current sensor (FOCS) with predetermined temperature dependence, for example, optical length. See K. Bohnert, P. Gabus, J. Nehring, H. Brändle, “Temperature and Vibration Insensitive Fiber-Optic Current Sensor”, J. Lightwave Technol., 20(2), 267, (2002).

The set-up shown in FIG. 4 illustrates that the light from the light source is sent through a first beam splitter 42, a first polarizer 43 and a second beam splitter 44 into the polarization maintaining fiber 45, which has already been connected under 45° to sensing fiber 13. First polarizer 43 is aligned to couple into only one polarization mode of polarization maintaining fiber 45. The light passes from polarization maintaining fiber 45 into both polarization modes of sensing fiber 13, is reflected by reflector 14, and returns back through sensing fiber 13 and polarization maintaining fiber 45. At second beam splitter 44, part of the light is deflected through a polarizer 46 (aligned with a polarization under 90° with respect to polarizer 43) and arrives at a first detector 47, while another part of the light passes through first polarizer 43, is deflected at first beam splitter 42 to arrive at a second detector 48. The detectors 47, 48 generate signals 51 and S2 respectively, whose ratio is a parameter describing the retardation in sensing fiber 13.

In this manner, the retardation of sensing fiber 13 is measured. If it has not yet dropped to the desired retardation, sensing fiber 13 is tempered. These steps are continued until the measured parameter indicates that the retardation has dropped to the desired retardation. This procedure is called “tuning”.

To finalize the sensing head and to obtain a product as shown in FIG. 5, the wide band polarizer 11 with a single mode fiber 50 and a single mode connector 31 on one side is attached at the other side to the polarization maintaining fiber 45 under an angle of 0° thereto, in one particular case by being spliced under an angle of 0° to the PM fiber 51 exiting the polarizer, such that the PM fiber 45 becomes a part or the entire lead fiber 12 of the final product. This has the advantage that the retardation in the region of the splice between lead fiber 12 and sensing fiber 13 is fully accounted for during the tuning process described above and is not changed anymore afterwards.

The sensing head can now be packaged and connected to any optoelectronics module and will deliver accurate temperature readings.

Instead of performing a single-wavelength measurement as shown in FIG. 4, the retardation can also be determined by using a two-wavelength measurement with a setup similar to the one shown in FIG. 1 or 2.

The light source assembly:

In accordance with an exemplary embodiment, light sources assembly 2 can use two light sources with different wavelengths (e.g., 1310 nm, 1550 nm). For cost reasons, the light sources can be distributed to serve multiple sensor heads (e.g. 8 for transformer applications, not shown), or cheap VCSEL sources around 850 nm may be used.

The light coming from the light sources 2a, 2b with two different wavelengths (modulated or not) may be used for several temperature measurement points. For this a star coupler may be used to distribute the light from the light sources 2a, 2b roughly equally among the measurement channels. The star coupler has to work simultaneously for both wavelengths. In this way, the cost for the light sources may be distributed among the approximately 10 measurement channels of an application in a transformer. The exact distribution of intensities among the channels will be monitored after the star coupler by using reference detectors such as detector 3 above.

It must be noted that the two waves traveling along a PM fiber experience a differential group delay, that is, waves originally fully in phase acquire a relative distance in time and space while traveling along two different modes of the PM fiber. The sensor configuration according to the present disclosure relies on the fact that the two waves split up at the 45° entrance splice will interfere with each other at the 45° exit splice after traveling along the fiber forth and back. The interference fringe visibility and consequently the sensor signal will be reduced if the two waves acquire a significant differential group delay compared to the coherence length of the employed light. A reduced fringe visibility will impair the signal to noise ratio of the sensor.

Examples of methods to maximize the interference contrast include (i) choice of a sensing fiber with a minimal differential group dispersion, and (ii) management of the light sources' coherence length.

An elliptical core fiber may be used as the sensing fiber 13, because this type of fiber allows one to tailor the properties by a correct design of parameters, such as core diameters and the core-cladding index difference. Fiber properties taken into consideration for the design process may include: birefringence, birefringence temperature dependence and differential group delay.

The coherence length of the employed light in the first as well as in the second spectral range should be long enough to guarantee a good sensor fringe visibility while being short enough to suppress effects from stray reflections at connectors and the like. The light source should be very stable in its coherence and wavelength properties. One option to achieve this property is the use of a super luminescent LED with an additional optical band pass filter to tailor the bandwidth and hence the coherence properties of the light. The optical filter may be placed anywhere in the optical path. In accordance with an exemplary embodiment, the spectral width of the first spectral range as well as of the second spectral range may be 1 nm to 30 nm.

Notes:

The exemplary embodiments described herein combine the cost effectiveness of a polarization measurement and the ruggedness of information transport when encoded as a wavelength pattern.

For handling fiber optic sensors during integration into HV equipment as well as to replace the read-out electronics after a decade while still using the same sensor head, it is advantageous to use cheap and rugged fiber optic connectors, for example, single mode connectors instead of PM (polarization-maintaining) connectors. Furthermore, sensor heads need to behave exactly the same with any electronics without any kind of recalibration. The here disclosed sensor design topology solves the first requirement, while the required identical sensing property of the sensing element is provided by the disclosed method for manufacturing.

The sensing fiber is electrically isolated from the electronics and vibration insensitive. The transmission fiber can be a single mode fiber with single mode connectors, which are cheap and robust. The transmission fiber and the connectors do not have to be polarization maintaining.

A “one-point” calibration during manufacturing is possible, as well as an accuracy of ±1° C. over a range of 160° C. Furthermore, the sensor constitutes an intrinsic fiber optical sensor. As such, no external sensor (e.g. cavity, GaAs chip, fluorescent material) needs to be attached to the fiber.

The method according to the present disclosure allows for a very simple and cost effective temperature measurement, because only a few, inexpensive components (e.g. at 850 nm or 1310 nm) are included. All components are commercially available for telecom applications.

While the present disclosure has been illustrated and described in detail in the drawings and the foregoing description, such illustration and description are to be considered illustrative or exemplary and not restricted; the disclosure is not limited to the disclosed embodiments.

Other variations of the disclosed embodiments may be understood and affected by those skilled in the art and practicing the present disclosure, from a study of the drawings, the disclosure, and the appended claims.

In the claims, the word “comprising” or “including” does not exclude other elements or steps, and the indefinite article “a” or “an” does not exclude a plurality. The mere fact that certain measures are recited in mutually different dependent claims does not indicate that a combination of these measures may not be used to advantage.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### REFERENCE NUMERALS

1: optoelectronic module

2, 2a, 2b: light source arrangement

3, 4: detectors

5: processing electronics

8: transmission fiber

10: sensing head

11: polarizer

12: lead fiber

13: sensing fiber

14: reflector

15: combiner

16: coupler

17: reference branch

18: measurement branch

19: detection branch

20, 21: reference detectors

22, 23: (spectral) filters

24, 25: signal detectors

26, 27: filters

30, 31: single-mode connectors

35, 36: amplitude modulators

37, 38, 39, 40: (frequency) bandpass filters

41: tempering chamber

42: beam splitter

43: polarizer

44: beam splitter

45: polarization maintaining fiber

46: polarizer

47, 48: detectors

50: single-mode fiber

51: polarization maintaining fiber

What is claimed is:

1. A fiber optic thermometer comprising:
a light source assembly configured to generate light in a first spectral range and in a second spectral range, the first spectral range differing from the second spectral range;
a single-mode transmission fiber connected to the light source assembly and configured to carry the light of the first and second spectral ranges;
a polarizer configured to polarize light from the transmission fiber;
a polarization maintaining sensing fiber having first and second birefringence axes, wherein a birefringence of the sensing fiber between the first and second birefringence axes depends on a temperature to be measured, and the polarizer is configured to couple light from the light source into both the birefringence axes, the sensing fiber having a first end and a second end, and the polarizer being arranged between the transmission fiber and the first end;
a reflector arranged at the second end of the sensing fiber and configured to reflect light back into the sensing fiber;
a detector assembly configured to detect light returning from the sensing fiber through the polarizer and the single-mode transmission fiber, wherein the detector assembly is configured to generate a first signal A indicative of an intensity of returning light in the first spectral range and a second signal B indicative of an intensity of returning light in the second spectral range; and
processing circuitry configured to generate a temperature signal from the first signal A and the second signal B,
wherein the processing circuitry is configured to calculate a temperature signal S from the first signal A and the second signal B that is an unambiguous function of the temperature over a desired temperature range.

2. The thermometer of claim 1, comprising:
a polarization maintaining lead fiber having first and second birefringence axes and being arranged between the polarizer and the first end of the sensing fiber, wherein the birefringence axes of the lead fiber are parallel and perpendicular to a polarization direction of the polarizer and at an angle between 40° and 50°, in particular at an angle of 45°, with respect to the birefringence axes of the sensing fiber.

3. The thermometer of claim 2, wherein the polarizer is at a distance from the sensing fiber such that only the sensing fiber, but not the polarizer is at the temperature to be measured.

4. The thermometer of claim 1, comprising:
a first single-mode connector between the transmission fiber and the light source assembly.

5. The thermometer of claim 1, comprising:
a second single-mode connector between the transmission fiber and the polarizer.

6. The thermometer of claim 5, wherein the first single-mode connector and the second single-mode connector are not polarization maintaining connectors.

7. The thermometer of claim 1, wherein the transmission fiber is not a polarization maintaining fiber.

8. The thermometer of claim 1, wherein the light source assembly comprises:
a first light source configured to generate light in the first spectral range; and
a second light source configured to generate light in the second spectral range.

9. The thermometer of claim 8, comprising:
an optoelectronic module which includes the light source assembly, the detector assembly, and the processing circuitry,
wherein the optoelectronic module includes:
a combiner configured to combine the light from the light sources of the light source assembly;
a coupler configured to couple part of the light from the combiner into a reference branch and a measurement branch, and to couple part of the light coming back from the measurement branch into a detection branch,
wherein all of these components are implemented as waveguides and are not polarization maintaining and are working at both spectral regions simultaneously.

10. The thermometer of claim 1, wherein the processing circuitry is configured to combine the first signal A and the second signal B by calculating a quantity depending on (A−B)/(A+B).

11. The thermometer of claim 1, wherein the detector assembly is configured to detect:
a first raw intensity signal SA₀ indicative of an intensity of light of the first spectral range as generated by the light source assembly;
a first raw return signal SA indicative of an intensity of light of the first spectral range returning through the transmission fiber;
a second raw intensity signal SB₀ indicative of an intensity of light of the second spectral range as generated by the light source assembly; and
a second raw return signal SB indicative of an intensity of light of the second spectral range returning through the transmission fiber, wherein the first signal A is indicative of SA/SA₀, and the second signal B is indicative of SB/SB₀.

12. The thermometer of claim 1, wherein the light source assembly comprises:
a first amplitude modulator configured to modulate an intensity of light in the first spectral range with a first frequency; and
a second amplitude modulator configured to modulate an intensity of light in the second spectral range at a second frequency different from the first frequency, and
wherein the detector assembly comprises:
a light detector;
a first bandpass filter at the first frequency; and
a second bandpass filter at the second frequency,
wherein both the filters are connected to the light detector.

13. The thermometer of claim 1, wherein the first spectral range and the second spectral range each has a spectral width between 1 nm and 30 nm.

14. The thermometer of claim 1, wherein the thermometer is configured to measure a temperature of at least one of a generator circuit breaker and a power transformer.

15. The thermometer of claim 2, wherein the birefringence axes of the lead fiber are parallel and perpendicular to a polarization direction of the polarizer at an angle of 45° with respect to the birefringence axes of the sensing fiber.

16. The thermometer of claim 3, comprising:
a first single-mode connector between the transmission fiber and the light source assembly.

17. The thermometer of claim 16, comprising:
a second single-mode connector between the transmission fiber and the polarizer.

18. The thermometer of claim 17, wherein the first single-mode connector and the second single-mode connector are not polarization maintaining connectors.

19. The thermometer of claim 17, wherein the light source assembly comprises:
a first light source configured to generate light in the first spectral range; and
a second light source configured to generate light in the second spectral range.

20. The thermometer of claim 19, comprising:
an optoelectronic module which includes the light source assembly, the detector assembly, and the processing circuitry,
wherein the optoelectronic module includes:
a combiner configured to combine the light from the light sources of the light source assembly;
a coupler configured to couple part of the light from the combiner into a reference branch and a measurement branch, and to couple part of the light coming back from the measurement branch into a detection branch,
wherein all of these components are implemented as waveguides and are not polarization maintaining and are working at both spectral regions simultaneously.

21. The thermometer of claim 1, wherein the processing circuitry is configured to combine the first signal A and the second signal B by calculating a quantity depending on log(A/B).

22. The thermometer of claim 17, wherein the detector assembly is configured to detect:
a first raw intensity signal SA₀ indicative of an intensity of light of the first spectral range as generated by the light source assembly;
a first raw return signal SA indicative of an intensity of light of the first spectral range returning through the transmission fiber;
a second raw intensity signal SB₀ indicative of an intensity of light of the second spectral range as generated by the light source assembly; and
a second raw return signal SB indicative of an intensity of light of the second spectral range returning through the transmission fiber, wherein the first signal A is indicative of SA/SA₀, and the second signal B is indicative of SB/SB₀.

23. The thermometer of claim 17, wherein the light source assembly comprises:
a first amplitude modulator configured to modulate an intensity of light in the first spectral range with a first frequency; and
a second amplitude modulator configured to modulate an intensity of light in the second spectral range at a second frequency different from the first frequency, and
wherein the detector assembly comprises:
a light detector;
a first bandpass filter at the first frequency; and
a second bandpass filter at the second frequency,
wherein both the filters are connected to the light detector.

24. A method for manufacturing fiber optic thermometer, the method comprising:
arranging a light source assembly configured to generate light in a first spectral range and in a second spectral range, the first spectral range differing from the second spectral range;
arranging a single-mode transmission fiber connected to the light source assembly and carrying the light of the first and second spectral ranges;
arranging a polarizer configured to polarize light from the transmission fiber;
arranging a polarization maintaining sensing fiber having first and second birefringence axes, wherein a birefringence of the sensing fiber between the first and second birefringence axes depends on a temperature to be measured, and the polarizer is configured to couple light from the light source into both the birefringence axes, the sensing fiber having a first end and a second end, and the polarizer being arranged between the transmission fiber and the first end;
arranging a reflector arranged at the second end of the sensing fiber and configured to reflect light back into the sensing fiber;
arranging a detector assembly configured to detect light returning from the sensing fiber through the polarizer and the single-mode transmission fiber, wherein the detector assembly is configured to generate a first signal A indicative of an intensity of returning light in the first spectral range and a second signal B indicative of an intensity of returning light in the second spectral range;
arranging processing circuitry configured to generate a temperature signal from the first signal A and the second signal B, the processing circuitry being configured to calculate a temperature signal S from the first signal A and the second signal B that is an unambiguous function of the temperature over a desired temperature range;
providing the sensing fiber to have an original birefringent retardation exceeding a desired birefringent retardation;
sending light through the sensing fiber polarized along the first and the second birefringence axes of the sensing fiber;
measuring a parameter depending on a current retardation in the sensing fiber; and
permanently reducing the birefringence of the sensing fiber by tempering the sensing fiber until the parameter indicates that the current retardation is equal to the desired retardation.

25. The method of claim 24, wherein the step of providing the sensing fiber comprises:
providing the sensing fiber with a polarization maintaining fiber attached, wherein the birefringence axes of the polarization maintaining fiber are arranged under an angle in the range of 40°-50° with respect to the birefringence axes of the sensing fiber, and wherein the method comprises:
after completing the step of permanently reducing the birefringence of the sensing fiber, attaching the polarization maintaining fiber to the polarizer or a PM fiber exiting the polarizer under angle of 0°.

26. The method of claim 25, wherein the birefringence axes of the polarization maintaining fiber are arranged under an angle of 45° with respect to the birefringence axes of the sensing fiber.

27. The method of claim 24, wherein the processing circuitry of the thermometer is replaceable without recalibration.
